(19) United States
(12) Patent Application Publication
(10) Pub. No.: US 2026/0108985 A1
(43) Pub. Date: Apr. 23, 2026

(54) LASER WELDING DEVICE

(71) Applicants: Hyundai Motor Company, Seoul (KR); Kia Corporation, Seoul (KR)

(72) Inventors: Tae Heun JIN, Hwaseong-si (KR); Chae Won LIM, Hwaseong-si (KR); Sang Min JUNG, Hwaseong-si (KR); Min Sun SIM, Hwaseong-si (KR); Byeong Gi YOO, Hwaseong-si (KR)

(21) Appl. No.: 19/309,036

(22) Filed: Aug. 25, 2025

(30) Foreign Application Priority Data
Oct. 18, 2024 (KR) 10-2024-0143444
Jan. 31, 2025 (KR) 10-2025-0012185

(51) Int. Cl. B23K 26/21; B23K 26/08; B23K 37/04

(52) U.S. Cl. CPC B23K 26/21; B23K 26/0869; B23K 37/04

(57) ABSTRACT

A laser welding device is configured to weld a material using a laser beam. The device can include a laser scanner configured to supply a laser beam to weld a material, at least a pair of bars configured to press the material, and a cover configured to shield the laser beam applied to the material.

### CROSS-REFERENCE TO RELATED APPLICATIONS

This application claims, under 35 U.S.C. § 119(a), the benefit of and priority to Korean Patent Application No. 10-2024-0143444, filed on Oct. 18, 2024, and Korean Patent Application No. 10-2025-0012185, filed on Jan. 31, 2025, the entire contents of each of which are incorporated herein by reference.

### TECHNICAL FIELD

The present disclosure relates to a welding device and a welding method, and more particularly, to a laser welding device and a laser welding method.

### BACKGROUND

Laser welding may be used to join metals and the like using a focused laser beam. Laser welding may be used in areas that require high precision and high speed, especially in areas where automation may be beneficial, such as battery and automobile manufacturing processes.

### SUMMARY

The present disclosure describes a laser welding device and a laser welding method that can provide consistent and excellent welding quality.

Aspects of the present disclosure can provide a laser welding device that can facilitate the application of laser welding.

According to some aspects of the present disclosure, a laser welding device can include a laser scanner configured to supply a laser beam to weld a material; and at least a pair of bars configured to press the material to be welded, the pair of bars including a first bar and a second bar, wherein a position of each of the first bar and the second bar with respect to the material is adjustable based on a surface of the material that each of the first and second bars face.

According to some aspects of the present disclosure, a laser welding system can include a laser welding device configured to weld a material using a laser beam, wherein the laser welding device comprises: at least a pair of bars configured to press the material to be welded, the pair of bars including a first bar and a second bar; and a cover configured to shield the laser beam applied to the material; a multi-axis robot on which the laser welding device is mounted and configured to guide a movement path of the laser welding device; and a controller configured to control operations of the laser welding device and the multi-axis robot, wherein the controller is configured to adjust a position of each of the fist bar and the second bar with respect to the material based on a surface of the material that each of the first bar and the second bar face.

According to some aspects of the present disclosure, a laser welding method can include applying a pressure to a material to be welded through at least a pair of bars of a laser welding device, the pair of bars including a first bar and a second bar; adjusting a position of each of the first bar and the second bar with respect to the material based on a surface of the material that each of the first bar and the second bar face; determining, by a position sensor of the laser welding device, the position of each of the first bar and the second bar; and determining whether to perform a welding of the material based on the detected position of the first bar and the second bar.

### BRIEF DESCRIPTION OF THE DRAWINGS

The above and other features of the present disclosure will now be described in detail with reference to some implementations thereof illustrated in the accompanying drawings which are given herein below by way of illustration only, and thus are not limitative of the present disclosure.

FIG. 1 illustrates an example of a laser welding system according to some implementations of the present disclosure.

FIG. 2 illustrates an example of a laser welding device according to some implementations of the present disclosure.

FIG. 3 illustrates an example of a laser welding device according to some implementations of the present disclosure, showing the flow of a laser beam.

FIG. 4 illustrates an example of a laser welding device according to some implementations of the present disclosure, where a housing and a cover are transparently illustrated.

FIG. 5 is a front view of an example of a laser welding device according to some implementations of the present disclosure, where a housing is transparently illustrated and a cover is removed.

FIG. 6 depicts an example of a laser welding device according to some implementations of the present disclosure, illustrating a state in which a portion of a housing is removed and a cover is mounted.

FIG. 7 is a front view of an example of a laser welding device according to some implementations of the present disclosure, illustrating a state in which a portion of a housing is removed and a cover is removed.

FIG. 8A illustrates an example of a cover of a laser welding device according to some implementations of the present disclosure.

FIG. 8B is a perspective view of an example of a laser welding device according to some implementations of the present disclosure.

FIG. 8C is an enlarged view of the portion indicated by a dotted line in FIG. 8B.

FIG. 8D illustrates an example of a block wall of a laser welding device according to some implementations of the present disclosure.

FIG. 8E is a cross-sectional view of one side of an example of a laser welding device according to some implementations of the present disclosure.

FIG. 9 is a flowchart illustrating an example process of operating a laser welding device according to some implementations of the present disclosure.

### DETAILED DESCRIPTION

Descriptions of specific structures or functions presented in the implementations of the present disclosure are merely exemplary for the purpose of explaining the implementations according to the concept of the present disclosure, and the implementations according to the concept of the present disclosure can be implemented in various forms. In addition, the descriptions should not be construed as being limited to the implementations described herein, and should be understood to include all modifications, equivalents and substitutes falling within the idea and scope of the present disclosure.

Meanwhile, in the present disclosure, terms such as “first” and/or “second” can be used to describe various components, but the components are not limited by the terms. These terms are only used to distinguish one component from another. For example, a first component could be termed a second component, and similarly, a second component could be termed a first component, without departing from the scope of exemplary implementations of the present disclosure.

Throughout the specification, like reference numerals indicate like components. The terminology used herein is for the purpose of illustrating implementations and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

Hereinafter, the present disclosure is described in detail with reference to the accompanying drawings.

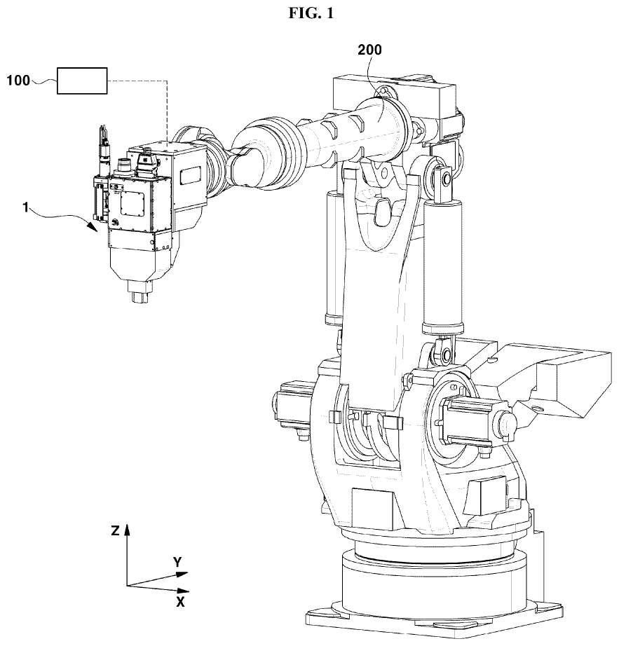

As illustrated in FIG. 1, according to some implementations of the present disclosure, a laser welding system can include a laser welding device 1, a controller 100, and a multi-axis robot 200.

The controller 100, which is programmable, can be configured to control the operations of the laser welding device 1 and the multi-axis robot 200. The controller 100 can be configured to control the operations of the laser welding device 1 and the multi-axis robot 200 based on a predetermined operation path of the laser welding device 1. In some implementations, the controller 100 can include one or more controllers configured to control the laser welding device 1 and one or more controllers configured to control the multi-axis robot 200. In some other implementations, the controller 100 can include one or more integrated controllers configured to control both the laser welding device 1 and the multi-axis robot 200.

According to some implementations of the present disclosure, the laser welding device 1 can be mounted on the multi-axis robot 200. The movement path of the laser welding device 1 can be guided by the multi-axis robot 200. In some implementations, the multi-axis robot 200 can be a robot having at least four axes.

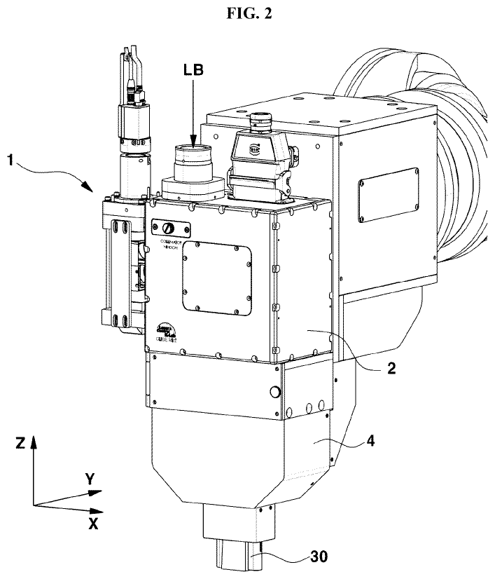

As illustrated in FIG. 2, the laser welding device 1 is configured to weld a material. In some implementations, the laser welding device 1 can be configured to weld a material using a laser beam (LB) supplied from a laser generator. The laser welding device 1 can weld a plurality of overlapping materials to one another. In some implementations, the material can include a metal, an alloy, and/or a non-metal. For example, the material can include steel, copper, and/or or aluminum.

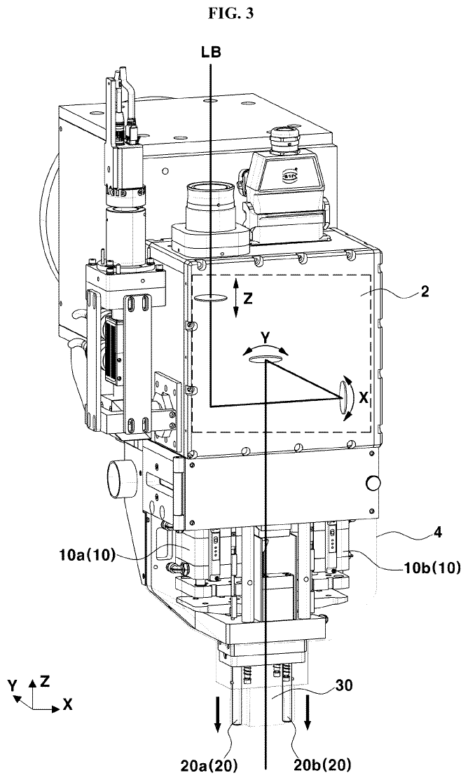

Referring to FIG. 3, the laser welding device 1 can include a scanning area and a tool area. The laser welding device 1 can include a laser scanner 2 in the scanning area. The laser scanner 2 can be configured to control the optical path of the laser beam (LB). In the scanning area, the focus of the laser beam (LB) can be scanned. In the tool area, a welding target can be pressed and the laser beam (LB) can be shielded. Moreover, through the tool area, the laser beam (LB) can be applied to a material to be welded.

According to some aspects of the present disclosure, the laser welding device 1 can enable high-speed and high-quality welding, for example, by using the laser scanner 2. The laser scanner 2 can include a plurality of mirrors. In some implementations, the laser scanner 2 can be a galvanometer scanner, a polygon scanner, or an acusto-optic deflector. The laser scanner 2 can be controlled simultaneously with the operation of the multi-axis robot 200 to enable high-quality welding. In some implementations, the laser scanner 2 can be a three-dimensional laser scanner. The laser scanner 2 can enable high-speed scanning in x-axis and y-axis and real-time correction of z-axis height. Accordingly, various patterns of laser beam (LB) can be used, and welding quality can be secured.

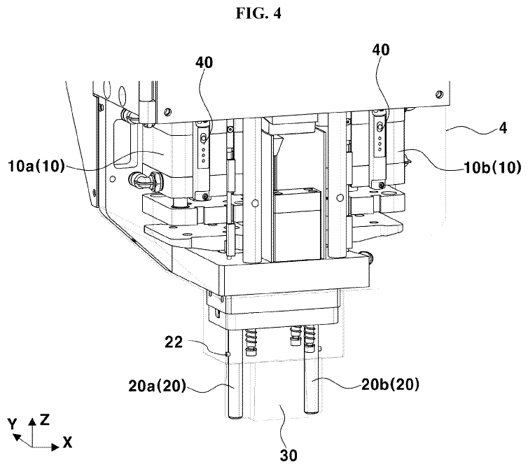

As illustrated in FIG. 4, a housing 4 can be arranged in the tool area. The laser beam (LB) through the laser scanner 2 can be directed to the material to be welded through the housing 4. At least a pair of bars 20 can be arranged in the housing 4. The pair of bars 20 can include a first bar 20a and a second bar 20b. However, the number of bars 20 can vary.

The bar 20 can be configured to press the material to be welded. In some implementations, the bar 20 can be operably connected to an actuator 10 to press the material to be welded. In some implementations, the laser welding device 1 can be operated without having to use a separate jig clamp, which is typically used in the related art, by using the bar 20 configured to press the material to be welded.

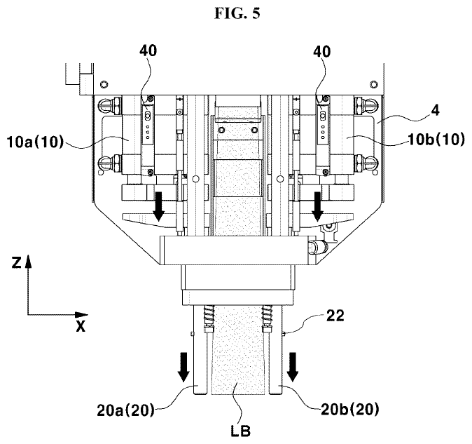

Referring to FIG. 5, the actuator 10 may include a first actuator 10a and a second actuator 10b. In some implementations, the pair of bars 20 can be operably coupled to the actuators 10a, 10b. For example, the first actuator 10a can be configured to control the pressing force of the first bar 20a, and the second actuator 10b configured to control the pressing force of the second bar 20b. According to some aspects of the present disclosure, the pressing force of each of the bars 20a, 20b can be controlled by individually controlling each of the actuators 10a, 10b corresponding to each of the bars 20a, 20b. In some implementations, the pressing force of each bar 20 can be in a range of 20 to 1,000 Newtons (N). In some implementations, the actuator 10 can be a pneumatic actuator. The pressing force of the actuator 10 can be automatically controlled by an electric regulator. In some other implementations, the actuator 10 can be a hydraulic or electric actuator.

In some implementations, the position of the pair of bars 20a, 20b can be adjusted. For instance, the position of each of the bars 20a, 20b with respect to the material to be welded can be adjusted to align with the specific surface of the material the respective bar 20a, 20b faces. In some cases, the surface of the material to be welded may not be uniform. By adjusting the position of each of the bars 20a, 20b individually and/or separately, each bar 20a, 20b can adapt to the non-uniform/uneven surface of the material to be welded In some implementations, a real-time position of each of the bars 20a, 20b can be measured or detected, for example in response to the each of the bars 20a, 20b pressing the material to be welded. In some implementations, the laser welding device 1 can include a position sensor 40. The controller 100 can be configured to correct the z-axis height of the laser scanner 2 based on the data measured or detected by the position sensor 40, ensuring consistent welding quality. Based on the real-time position of the bar 20 measured by the position sensor 40, the position dispersion of the material to be welded can be monitored and welding and/or weldable conditions can be set.

The housing 4 can include a cover 30. The cover 30 can be configured to move along the bar 20. For example, the cover 30 can linearly move in the z-axis along the bar 20. The cover 30 can maintain a constant distance from a surface of the material to be welded.

Moreover, the laser beam (LB) can be applied to the material to be welded through the cover 30. The cover 30 can (directly) shield a scattered laser beam by removing welding fume and shielding the portion to be welded. In some aspects of the present disclosure, by using the cover 30, a laser booth that may be typically used in the related art can be omitted.

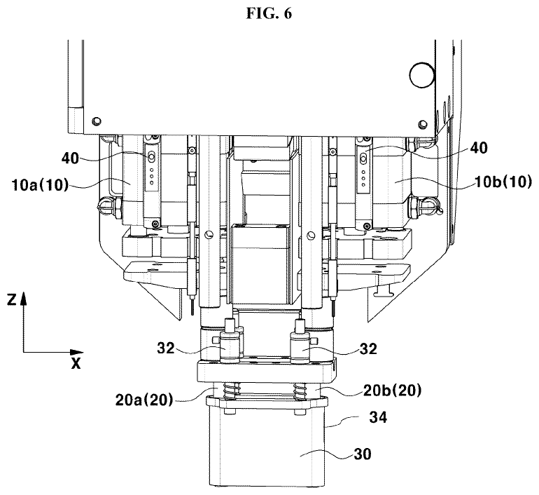

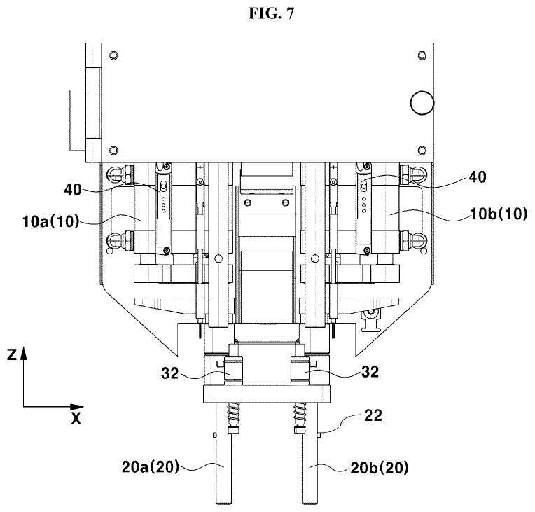

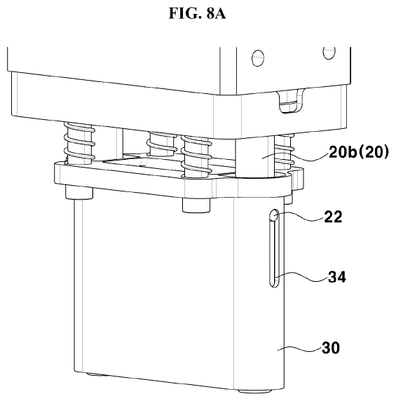

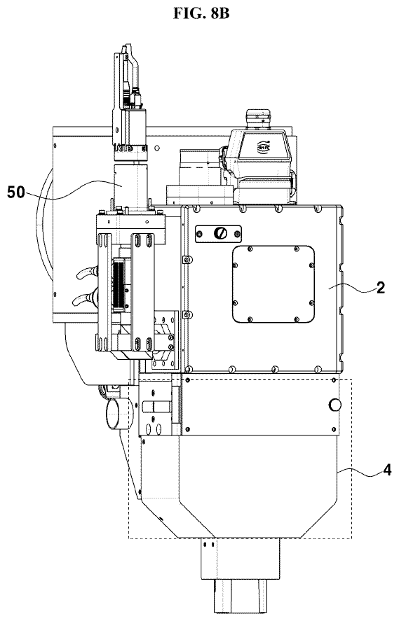

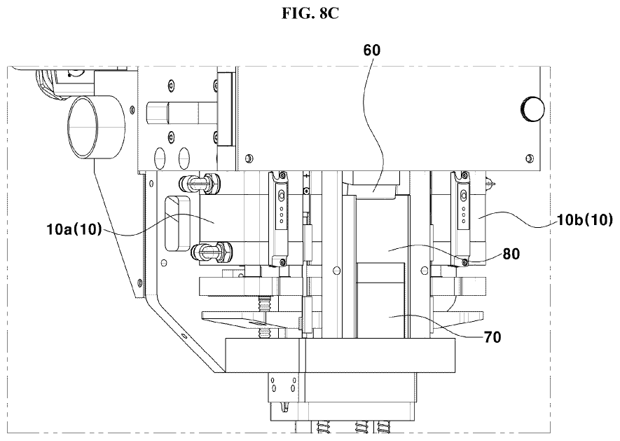

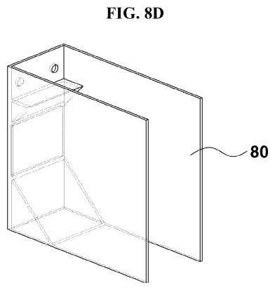

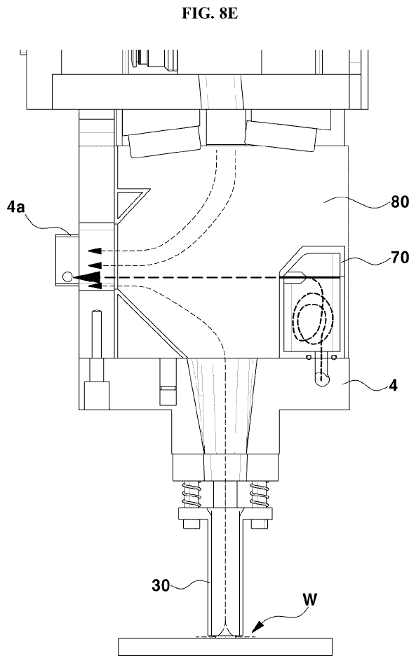

As illustrated in FIGS. 6 and 7, in some implementations, the cover 30 can be coupled to the housing 4 by a spring 32. The cover 30 can be aligned with an end of the bar 20 by the spring 32. In some implementations, the spring 20 can include a first spring aligned with the first bar 20a and a second spring aligned with the second bar 20b. Referring to FIG. 8A, each bar 20 can include a protrusion 22. The cover 30 can include a guide 34 configured to allow the protrusion 22 to move through the guide 34. For example, the cover 30 may include a first guide corresponding to the protrusion of the first bar 20a and a second guide corresponding to the protrusion of the second bar 20b. The movement of the cover 30 can be guided (e.g., regulated or limited) by the protrusion 22 and the guide 34.

As illustrated in FIG. 8B, the laser welding device 1 can include a camera 50. In some implementations, the camera 50 can be arranged coaxially with the laser scanner 2. The camera 50 can be configured to photograph the portion welded by the laser welding device 1. In some implementations, the camera 50 can be a machine vision camera. One or more images of the welded portion photographed by the camera 50 can be transmitted to the controller 100. The controller 100 can collect and process the transmitted one or more images.

As illustrated in FIG. 8C, according to some implementations of the present disclosure, the laser welding device 1 can include a lighting 60. The lighting 60 can be arranged on the path of the laser beam (LB) in the laser welding device 1. In some implementations, the lighting 60 can be arranged on the path of the laser beam (LB) within the housing 4. For example, the lighting 60 can be arranged at the bottom of the laser scanner 2. The lighting 60 can be configured to provide light when capturing an image of the welded portion by the camera 50 after welding is completed. The lighting 60 can be arranged to have a predetermined angle. By optimizing the angle of the lighting 60, aspects of the present disclosure can provide light for the camera 50 to obtain the one or more images.

The laser welding device 1 can include a cross jet generator 70. The cross jet generator 70 can be arranged within the housing 4. The cross jet generator 70 can effectively remove spatter, fume, and the like generated during welding. For example, the cross jet generator 70 can be configured to generate a flow of compressed fluid, such as compressed air, to prevent optical contamination of the laser scanner 2 and effectively remove fume around the welded portion.

As illustrated in FIG. 8D, according to some implementations of the present disclosure, a block wall 80 can be provided within the housing 4. The block wall 80 can be arranged to surround and/or be disposed outside a periphery of the path of the laser beam (LB) within the housing 4. Moreover, the block wall 80 can be arranged to surround and/or be disposed outside a periphery of the cross jet generator 70. In some implementations, the block wall 80 can be arranged between the actuators 10a and 10b. The block wall 80 can prevent spatter generated during welding from flowing into other elements of the laser welding device 1, such as the actuator 10, the bar 20, and the like. In some implementations, the block wall 80 can be configured to utilize the pressure difference created by the flow of the compressed fluid during operation of the cross jet generator 70 and to limit the flow of the compressed fluid. Accordingly, the block wall 80 can effectively take in the fumes around the welded portion below the housing 4.

Specifically, FIG. 8E illustrates the flow of compressed fluid during operation of the cross jet generator 70. During the operation of the cross jet generator 70, a flow of fluid that sucks air around the welded portion W into the housing 4 through the cover 30 can be created. Spatter, fume, and the like can be effectively discharged through an outlet 4a configured to connect a space within the block wall 80 to the outside of the housing 4. In some implementations, a structure capable of capturing compressed fluid can be provided around the outlet through which the compressed fluid is discharged from the block wall 80.

The structure can perform the function of collecting compressed fluid so as to allow the compressed fluid to be effectively discharged to the outlet during the operation of the cross jet generator 70. In some implementations, the structure can include an inclined surface facing the outlet.

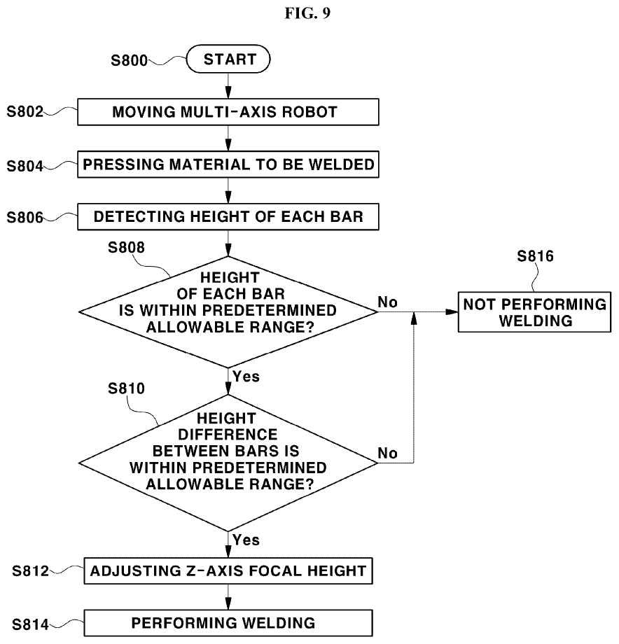

According to some implementations of the present disclosure, the laser welding device 1 can be operated as follows. Referring to FIG. 9, when the welding process starts at operation S800, the controller 100 can be configured to move the multi-axis robot 200 to a welding position at operation S802. The bar 20 can be placed on a material to be welded and can be configured to press the material to be welded with a predetermined pressing force by the controller 100 or the electric regulator at operation S804.

The controller 100 can be configured to communicate with the position sensor 40. The controller 100 can detect the height of each bar 20 using the position sensor 40 and determine whether welding is possible at the corresponding position at operation S806. Here, the height or position of each bar 20 detected by the controller 100 can be a position at which each bar 20 is drawn into or drawn out from the housing 4 with respect to a predetermined original position. That is, the height or position of each bar 20 detected by the controller 100 can be a position relative to the original position.

In some implementations, the controller 100 can be configured to determine whether welding is possible based on the detected height of each bar 20. In some implementations, the controller 100 can be configured to determine whether the position of each bar 20 is within a first predetermined allowable range at operation S808. In some implementations, the controller 100 is configured to determine whether, in addition to the whether the position of each bar 20 is within the first predetermined allowable range, a position difference or a height difference between the two bars 20 is within a second predetermined allowable range at operation S810. In response to determining that these two conditions are satisfied, the controller 100 can be configured to correct the z-axis position of the laser scanner 2 and adjust the focal height of the laser beam (LB) to match the detected position value of the bar 20 at operation S812. Then, the controller 100 can control the laser welding device 1 to perform welding at operation S814. In some implementations, in response to determining that at least one of the two conditions (operations S808 and S810) is not satisfied, the controller 100 can be configured to not perform welding at operation S816. According to some aspects of the present disclosure, when the height of the bar 20 and/or the height difference of the bars 20 is not within the first predetermined allowable range and/or second predetermined allowable range, the controller can determine that an unexpected problem has occurred and does not perform the welding operation. In some implementations, the controller can determine to perform the welding operation when the height of the bar 20 and the height difference of the bars 20 are within the first predetermined allowable range and second predetermined allowable range, respectively, thereby ensuring welding quality and increasing reliability.

In some implementations, the laser welding device 1 according to some aspects of the present disclosure can be applied to a welding process of a vehicle body. For example, by employing laser welding instead of mechanical fastening for unidirectional joints between aluminum materials, the cost of auxiliary materials (e.g., rivets) can be reduced.

A laser welding device according to some aspects of the present disclosure can provide consistent and excellent welding quality.

A laser welding device according to some aspects of the present disclosure can facilitate the application of laser.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described implementations and the accompanying drawings, and various substitutions, modifications and changes are possible within a range that does not depart from the technical idea of the present disclosure.

What is claimed is:

1. A laser welding device comprising:
a laser scanner configured to supply a laser beam to weld a material; and
at least a pair of bars configured to press the material to be welded, the pair of bars including a first bar and a second bar,
wherein a position of each of the first bar and the second bar with respect to the material is adjustable based on a surface of the material that each of the first and second bars face.

2. The laser welding device of claim 1, further comprising at least a pair of actuators, the pair of actuators including:
a first actuator configured to adjust a pressing force of the first bar; and
a second actuator configured to adjust a pressing force of the second bar.

3. The laser welding device of claim 1, wherein the laser scanner is configured to control an optical path of the laser beam.

4. The laser welding device of claim 1, further comprising:
a housing in which the first and second bars are arranged ; and
a cover operably connected to the housing and configured to shield the laser beam applied to the material to be welded.

5. The laser welding device of claim 4, further comprising one or more springs configured to movably connect the cover to the housing.

6. The laser welding device of claim 4, further comprising:
a camera configured to obtain an image of a welded portion of the material; and
a lighting arranged within the housing and configured to provide light to the welded portion.

7. The laser welding device of claim 4, further comprising a cross jet generator arranged within the housing and configured to generate a flow of compressed fluid.

8. The laser welding device of claim 7, further comprising a block wall arranged within the housing by being disposed outside a periphery of the cross jet generator and a path of the laser beam passing through the housing.

9. The laser welding device of claim 1, further comprising:
a position sensor configured to detect a position of each of the first bar and the second bar; and
a controller configured to determine whether the material is weldable by the laser welding device based on the detected position of each of the first bar and the second bar.

10. The laser welding device of claim 9, wherein the controller is configured to:
determine whether the position of each of the first bar and the second bar is within a first predetermined allowable range;
determine whether a position difference between the first and second bars is within a second predetermined allowable range; and
perform a welding of the material based on (i) the position of each of the first bar and the second bar being within the first predetermined allowable range, and (ii) the position difference between the first and second bars being within the second predetermined allowable range.

11. The laser welding device of claim 10, wherein the controller is configured to, based on i) the position of each of the first bar and the second bar being within the first predetermined allowable range, and ii) the position difference between the first and second bars being within the second predetermined allowable range, transmit the detected position and the position difference to the laser scanner to adjust a focus of the laser beam.

12. The laser welding device of claim 10, wherein the controller is configured to, based on at least one of i) the position of each of the first bar and the second bar not being within the first predetermined allowable range, or ii) the position difference between the first and second bars not being within the second predetermined allowable range, not perform the welding of the material.

13. A laser welding system comprising:
a laser welding device configured to weld a material using a laser beam, wherein the laser welding device comprises:
at least a pair of bars configured to press the material to be welded, the pair of bars including a first bar and a second bar; and
a cover configured to shield the laser beam applied to the material;
a multi-axis robot on which the laser welding device is mounted and configured to guide a movement path of the laser welding device; and
a controller configured to control operations of the laser welding device and the multi-axis robot, wherein the controller is configured to adjust a position of each of the first bar and the second bar with respect to the material based on a surface of the material that each of the first bar and the second bar face.

14. A laser welding method comprising:
applying a pressure to a material to be welded through at least a pair of bars of a laser welding device, the pair of bars including a first bar and a second bar;
adjusting a position of each of the first bar and the second bar with respect to the material based on a surface of the material that each of the first bar and the second bar face;
determining, by a position sensor of the laser welding device, the position of each of the first bar and the second bar; and
determining whether to perform a welding of the material based on the detected position of the first bar and the second bar.

15. The laser welding method of claim 14, further comprising, based on the position of the first bar and the second bar not being within a first predetermined allowable range, not performing the welding of the material.

16. The laser welding method of claim 14, further comprising, based on the position of the first bar and the second bar being within the first predetermined allowable range, performing the welding of the material.

17. The laser welding method of claim 16, further comprising, before performing the welding of the material, adjusting a focus of a laser beam to correspond to the position of the first bar and the second bar using a laser scanner of the laser welding device.

18. The laser welding method of claim 14, wherein the determining whether to proceed the welding of the material comprises:
determining whether the position of each of the first bar and the second bar is within a first predetermined allowable range; and
determining whether a position difference between the first bar and the second bar is within a second predetermined allowable range.

19. The laser welding method of claim 18, further comprising, based on determining that i) the position of each of the first bar and the second bar is within the first predetermined allowable range and ii) the position difference between the first bar and the second bar is within the second predetermined allowable range, determining to perform the welding of the material.

20. The laser welding method of claim 14, further comprising positioning, by a multi-axis robot, the laser welding device over the material to be welded.
